(19) United States
(12) Patent Application Publication
(10) Pub. No.: US 2026/0167000 A1
(43) Pub. Date: Jun. 18, 2026

(54) POWER CONTROL SYSTEM WITH A POWER SPLITTER

(71) Applicant: GM Global Technology Operations LLC, Detroit, MI (US)

(72) Inventors: Suresh Gopalakrishnan, Troy, MI (US); Minh-Khai Nguyen, Troy, MI (US); Lei Hao, Shelby Township, MI (US); Chandra S. Namuduri, Troy, MI (US); Peng Peng, Rochester Hills, MI (US); Renato Amorim Torres, Pontiac, MI (US); Khorshed Mohammed Alam, Canton, MI (US)

(73) Assignee: GM Global Technology Operations LLC, Detroit, MI (US)

(21) Appl. No.: 18/985,828

(22) Filed: Dec. 18, 2024

(51) Int. Cl. B60L 1/00; B60L 1/02; B60L 53/20; B60L 58/27; H02J 7/00

(52) U.S. Cl. CPC B60L 1/006; B60L 1/02; B60L 53/20; B60L 58/27; H02J 7/865; B60L 2210/30; B60L 2210/42; B60L 2240/545

(57) ABSTRACT

Provided is a power control system and method for providing power from a first power source to an outlet while a battery is simultaneously being charged by the first power source. The first power source transmits electric power at a predetermined voltage and phase to an onboard charging control module which regulates the power to charge a battery. The power control system includes a third inverter configured to transmit the electric power directly from the first power source to the outlet in one of a plurality of phases. The system may further include a rectifier, a first inverter and a second inverter. The rectifier is coupled to the first power source and transmits power from the first power source to the third inverter. The first inverter and the second inverter are configured to charge the battery with a direct current.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a power distribution system for charging a battery while simultaneously providing power to an outlet. For instance, an electric vehicle includes a battery for powering a motor to drive the vehicle and vehicle electric components such as a head unit, lights, an air conditioning system and the like. Some electric vehicles include an outlet, which may be used by vehicle occupants to power electric devices such as cellular phones, tablets, and laptop computers to name a few. However, such outlets are typically not powered when the battery is being charged by a residential outlet or commercial power station.

The electric vehicle further includes an inlet for accepting power from a charger coupled to a power utility station or a residential home. The inlet may be configured to accept alternating current (“AC”) at 120 volts or at 240 volts and the voltage may be delivered in different phases.

Accordingly, it is desirable to have a power distribution system wherein the outlets may be operable to distribute power when the battery is being charged. It is also desirable to simplify conventional topography associated with an outlet. It is further desirable to adjust the wave form and voltage of the electric power to accommodate the battery and/or an outlet to which an electric device is to be coupled. It is further desirable to overcome the problems associated with charging a cold battery.

### SUMMARY

One aspect of the disclosure provides a power control system for use in an electric vehicle and configured to power to an outlet and a battery. The battery is configured to power a motor that is configured to drive the electric vehicle. The power control system is configured to provide power to the outlet and the battery from a first power source. The power control system includes an onboard charger module. The onboard charger module includes a first inverter, a second inverter, a winding machine, a rectifier, and a first processing unit. The first processing unit is configured to process the electric power from the first power source to charge the battery. The first processing unit includes a non-volatile memory that stores written instructions for the execution of the onboard charger module. The first inverter, the winding machine, and the second inverter are configured to transmit electric power from the first power source to the battery and the rectifier is configured to transform an alternating current from the first power source to a direct current. The power control system further includes a third inverter, a first switch and a second switch. The third inverter is electrically coupled to the rectifier and the first inverter. The first switch is interposed between the battery and the first inverter and the second switch is interposed between the battery and the second inverter. The first processing unit is further configured to retain the first switch and the second switch in an open position when the battery is being charged to provide a galvanic isolation between the battery and the third inverter while the battery is being charged and the third inverter transforms the direct current from the rectifier to an alternating current. The alternating current is transmitted to the outlet to allow a load to be powered while the battery is being charged.

Implementations of the disclosure may include one or more of the following optional features. In some implementations, the first switch is interposed between the battery and the second inverter and the second switch is interposed between the battery and the first inverter.

In some implementations, the power control system further includes a positive contact switch and a negative contact switch. The positive contact switch is interposed between a positive terminal of the battery and the second inverter and the negative contact switch is interposed between a negative terminal of the battery and the second inverter.

In some implementations, the third inverter may be configured to provide a voltage to the outlet in a single phase. Alternatively or in addition, the third inverter may be configured to provide a voltage to the outlet in at least two phases.

In some implementations, the power control system may further include an auxiliary power module, a heater and a sensor. The rectifier may be configured to bring a voltage and a current of the first power source into phase with the voltage and current of the battery. The sensor is configured to detect a temperature of the battery. The onboard charger module may be further configured to open the first switch and the second switch and close the positive contact switch and the negative contact switch when the voltage and the current of the first power source is in phase with the voltage and current of the battery and the temperature of the battery is above a predetermined threshold. The onboard charger module may be further configured to open the positive contact switch and the negative contact switch when the temperature of the battery is at or below the predetermined threshold. The onboard charger module may be further configured to close the first switch and the second switch when the battery provides power to the motor.

Another aspect of the disclosure is a method of providing electric power from a first power source to an outlet while simultaneously charging a battery of an electric vehicle. The battery is configured to power a motor that drives the electric vehicle. The method includes the steps of providing an onboard charger module configured to process the electric power from the first power source to charge the battery. The onboard charger module includes a first inverter, a second inverter, a winding machine and a rectifier. The rectifier transforms the electric power from an alternating current to a direct current. The first inverter transforms the direct current to an alternating current and transmits the alternating current to the winding machine. The winding machine transmits the alternating current to the second inverter. The second inverter transforms the alternating current to a direct current and transmits the direct current to the battery to charge the battery. The method includes the step of providing a third inverter electrically coupled to the rectifier and configured to transform the direct current from the rectifier to an alternating current and transmit the alternating current to the output while the battery is being charged.

In some implementations, the third invertor is configured to receive electric power in one of a single phase and three phases.

In some implementations, the method may further include the step of providing a first switch and a second switch. The first switch is interposed between the battery and the second inverter and the second switch is interposed between the battery and the first inverter. The method includes the step of keeping the first switch and the second switch open when the battery is being charged to provide a galvanic isolation between the electric power transmitted to the outlet and the battery during charging.

In some implementations, the method further includes the step of providing a positive contact switch and a negative contact switch. The positive contact switch is interposed between a positive terminal of the battery and the second inverter and the negative contact switch is interposed between a negative terminal of the battery and the second inverter. In such an implementation, the method may include the steps of: bringing a voltage and a current of the first power source into phase with the voltage and current of the battery; detecting a temperature of the battery, and closing the positive contact switch and the negative contact switch when the temperature of the battery is above a predetermined threshold; and providing a heater and turning on the heater to warm up the battery when the temperature of the battery is below the predetermined threshold.

In some implementations, the method may include the step of keeping the positive contact switch and the negative contact switch in an open position until the temperature of the battery is at or above the predetermined threshold.

In some implementations, the method may include the step of closing the first switch and the second switch when the battery provides power to the motor.

In some implementations, the third inverter is configured to step up and step down a voltage of the electric power.

### BRIEF DESCRIPTION OF THE DRAWINGS

The drawings described herein are for illustrative purposes only of selected configurations and are not intended to limit the scope of the present disclosure.

FIG. 1 is a schematic view of a conventional power control system having an outlet for providing power to a load;

FIG. 2 is a schematic view of the hardware and electric components for the outlet shown in FIG. 1;

FIG. 3 is a perspective view of a vehicle showing a power control system of the vehicle coupled to a first power source;

FIG. 4 is a schematic view of the power control system shown in FIG. 1 providing a split-phase voltage to the outlet from a three-phase voltage source;

FIG. 5 is a schematic view of the power control system shown in FIG. 1 providing a three-phase voltage to the outlet from a three-phase voltage source;

FIG. 6 is a schematic view of the power control system shown in FIG. 1 having a single-phase inverter and configured to provide a three-phase voltage to the outlet from a three-phase voltage source; and

FIG. 7 is a diagram showing the method of providing electric power from a first power source to an outlet while simultaneously charging a battery of an electric vehicle.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

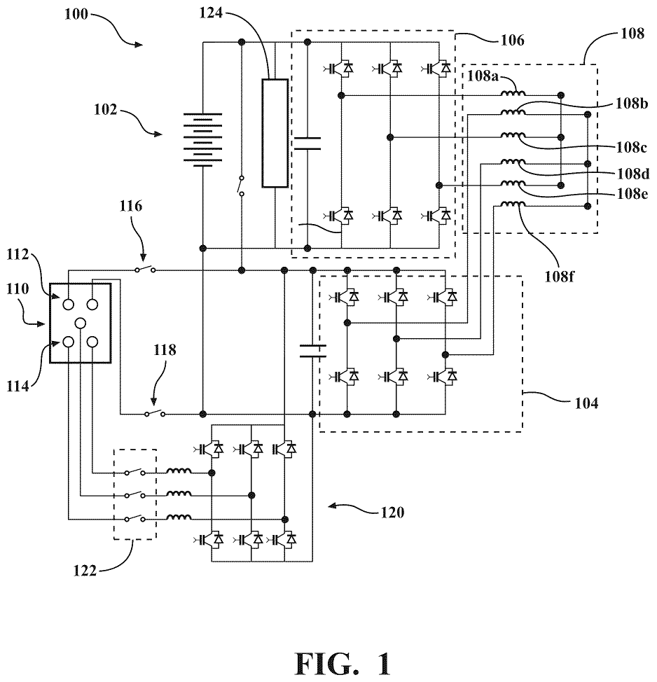

With reference now to FIG. 1, a conventional power control circuit 100 of an electric vehicle is provided. The power control circuit 100 includes a battery 102, a first inverter 104, a second inverter 106 and a winding machine 108. The first inverter 104 and the second inverter 106 are electrically separated from each other and can be powered using separate power modules and drivers. The first inverter 104 and the second inverter 106 each include a plurality of transistors or MOSFETs suitable for conversion between direct current (DC) and alternating current (AC). The winding machine 108 includes windings 108a-108f that are separated into two electrically isolated winding groups. Each winding group has its own neutral connection. Both winding groups share the same stator core and have the same rotor. The windings can be electromagnetically symmetric about the winding machine 108 to avoid any unbalance, to increase ease of control, etc., but can be electromagnetically unsymmetric about the winding machine 108 in other configurations. The winding machine 108 can be a wound-field synchronous machine, synchronous reluctance machine, etc.

With reference first to FIG. 1, a power control circuit 100 may be coupled to a first power source (not shown), such as commercial charger or residential outlet via a charging inlet 110. In one aspect, the charging inlet 110 may include a high voltage socket of the direct current (“DC”) port 112 and an alternating current (“AC”) port 114. The first inverter 104 may be coupled to the DC port 112 in which a pair of DC switches 116 and 118 may be opened and closed to control power supply to the first inverter 104. A front-end rectifier 120 is coupled to the AC port 114 wherein an AC switch 122 is opened and closed to control the supply of power to the front-end rectifier 120.

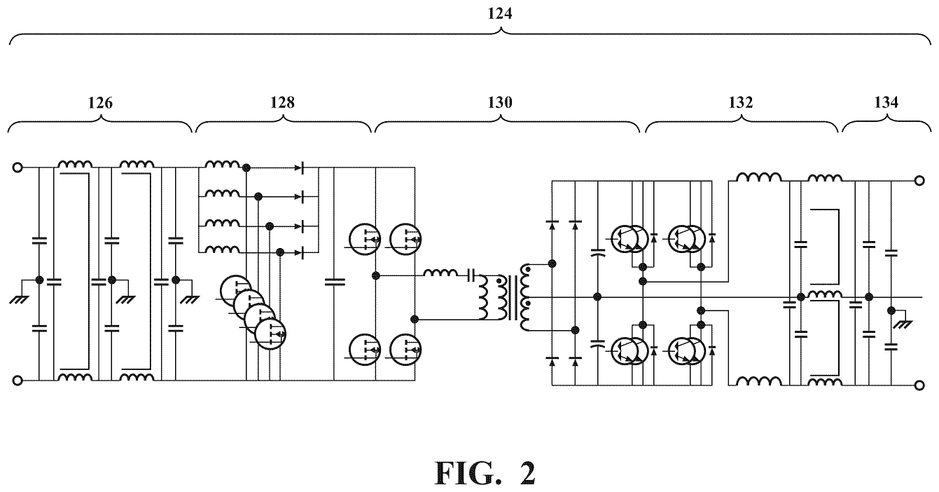

An outlet 124 is disposed between the battery 102 and the second inverter 106. With reference now to FIG. 2, a topology of the outlet 124 showing the hardware and electric components is provided. The hardware in the outlet 124 includes a filter 126 for filtering electromagnetic interference, a booster 128 for stepping up power from the battery 102, a resonant converter 130, a converter for 132 converting DC to AC and a second filter 134 to filter AC noise prior to transmission to the outlet 124. Such a topology adds cost and complexity to the power control circuit.

Further, the life cycle of a battery may deteriorate when the battery is charged while the battery is cold. When the battery is cold, the chemical reactions within the battery slow down, which may result in reduced charging capacity and may damage the battery. For instance, if the battery is below freezing, the electrolytes may freeze and expand causing a resistance of electrolytes to increase which in turn reduces the efficiency of the charge and the ability of the battery to hold a charge.

Further, the power source for charging the battery may differ in voltage and waveform. For instance, a commercial charging station may be configured to provide electric power at a greater voltage and at a different phase relative to a residential power outlet.

The present disclosure relates to a power control system 10 for providing power simultaneously to an outlet 12 and a battery 14 from a first power source 16, thus an electric device 18 may be powered by the outlet 12 while the battery 14 is being charged. The power control system 10 may be further configured to provide a galvanic isolation between the battery 14 and the outlet 12. In another aspect, the power control system 10 may be configured to execute a charging protocol to ensure the battery 14 is at a desired temperature prior to charging. In another aspect, the power control system 10 is configured to step up or down the voltage from the first power source 16 to the outlet 12. In yet another aspect, the power control system is configured to change a phase of the power from the first power source 16 to the outlet 12.

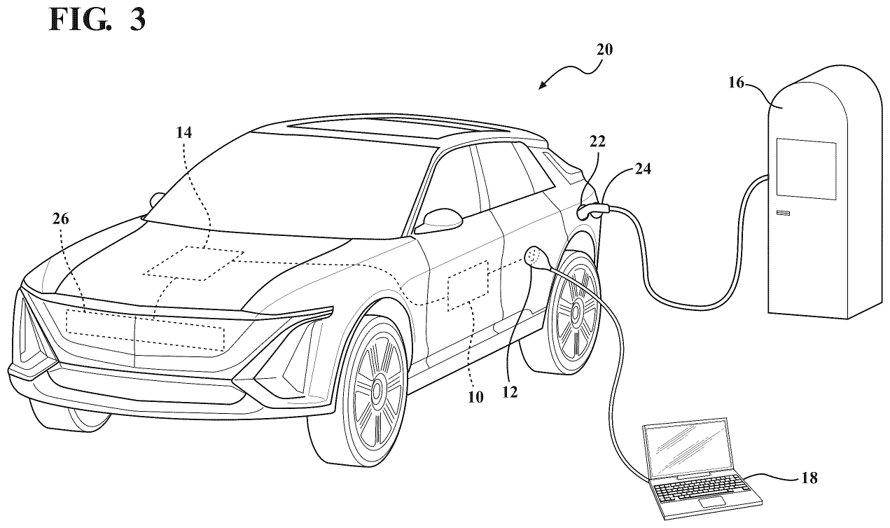

The first power source 16 may be a commercially developed charging station configured to provide electrical power at 240 volts, or may be a residential outlet configured to provide power at 120 volts, it should be further appreciated that the first power source 16 may be configured to provide power in the form of a direct current, for example DC fast charging station, or alternating current. The power control system 10 may be implemented in any platform or device that utilizes a battery 14 to power the device. For illustrative purposes, the power control system 10 is described in the context of an electric vehicle 20 as shown in FIG. 3. However, it should be appreciated that the power control system 10 may be implemented in other devices/platforms having a battery 14 for powering the device/platform and the outlet 12 for powering the electric device 18 such as a laptop computer. The power control system 10 may be implemented an any device/platform, illustratively including a boat, a motorcycle, a residential or commercial building and the like.

FIG. 3 depicts the vehicle 20 coupled to the first power source 16. In particular, the vehicle 20 includes a charging inlet 22 and the first power source 16 includes a charger 24 configured to be coupled with the charging inlet 22 to provide power to charge the battery 14. The first power source 16 is illustratively shown as a commercial charging station, but it should be appreciated that the first power source 16 may be a residential outlet as well.

The vehicle 20 is an electric vehicle and the battery 14 is configured to power a motor 26 for driving the vehicle 20. For instance, the motor 26 may be an electric motor configured to generate as much as 200 horsepower to drive the vehicle 20. Any battery 14 configured to be charged with electrical power currently known or later developed may be modified for use herein, illustratively including lithium-ion batteries, solid state batteries, and the like. The capacity of the battery 14 need not be limiting and may include batteries 14 having a capacity greater than 30 kilowatt-hours (kWh). The battery 14 is further configured to power the various electronic components within the vehicle 20. Such electronic components are well known and illustratively include lights, windshield wipers, a head unit, a heating, ventilation, and air conditioning (HVAC) system and the like.

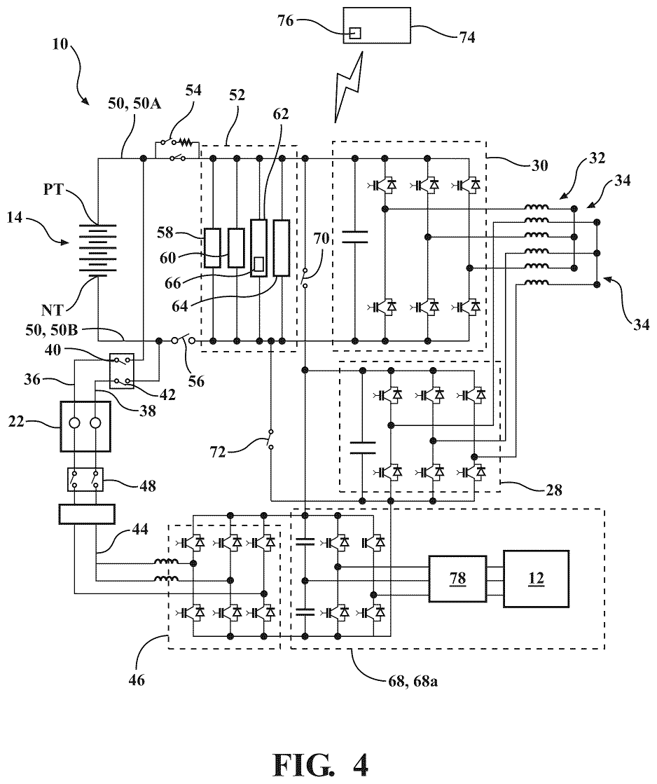

FIG. 4 shows a power control system 10 of the electric vehicle 20, in an exemplary configuration. The power control system 10 is coupled to the battery 14 and the first power source 16 via the charger 24. The power control system 10 includes a first inverter 28, a second inverter 30 and a winding machine 32. The first inverter 28 and the second inverter 30 are electrically separated from each other. The first inverter 28 and the second inverter 30 each include a plurality of transistors or a metal-oxide-semiconductor field-effect transistor (“MOSFET”) suitable for conversion between direct current (DC) and alternating current (AC). The winding machine 32 includes windings that are separated into two electrically isolated winding groups 34. Each winding group 34 has its own neutral connection. Both winding groups 34 share the same stator core and have the same rotor. The windings can be electromagnetically symmetric about the winding machine 32 to avoid any unbalance, to increase ease of control, etc., but can be electromagnetically unsymmetric about the winding machine 32 in other configurations. The winding machine 32 can be a dual winding machine wherein each winding machine is not directly connected but is inductively connected to each other. An exemplary winding machine includes a permanent magnet machine, a wound-field synchronous machine, a synchronous reluctance machine, or in general any AC machine.

The first inverter 28 can be used to convert between DC power at the first power source 16 and AC power at the electric motor 26. The second inverter 30 can be used to convert between DC power at the battery 14 to AC power at the electric motor 26. The power control system 10 can be coupled to the first power source 16 via a universal charger 24, which may be an outlet of an external power grid that includes both a direct current port and an alternating current port. The winding machine 32 may be incorporated within the electric motor 26.

The power control system 10 includes a high voltage DC bus 36 for connecting to a high voltage socket of the charging inlet 22 and a low voltage DC bus 38 for connecting to a low voltage socket of the charging inlet 22. A first DC port switch 40 controls a connection between the charging inlet 22 and the high voltage DC bus 36. A second DC port switch 42 controls a connection between the charging inlet 22 and the low voltage DC bus 38. An AC bus 44 extends between the charging inlet 22 and a front-end rectifier 46. An AC port switch 48 on the AC bus 44 controls a connection between the charging inlet 22 and the front-end rectifier 46. An inductor can be disposed on the AC bus 44. The front-end rectifier 46 decouples AC/DC power transfer between the charging inlet 22 and the other components of the power control system 10, such as the first inverter 28. The front-end rectifier 46 may be further configured to bring a voltage and current of the first power source 16 into phase with the voltage and current of the battery 14.

The power control system 10 includes a battery bus bar 50 having positive current portion 50A and a negative current portion 50B. One end of the positive current portion 50A is connected to a positive terminal (PT) of the battery 14 and the other end is connected to a vehicle load group 52 so as to be interposed between the positive terminal (PT) and the second inverter 30. One end of the negative current portion 50B is connected to a negative terminal (NT) of the battery 14 and the other end is connected to a vehicle load group 52 so as to be interposed between the positive terminal (PT) and the second inverter 30. A positive contact switch 54 is disposed on the positive current portion 50A and is interposed between the positive terminal (PT) of the battery 14 and the vehicle load group 52. A negative contact switch 64 is disposed on the negative current portion 50B and is interposed between the negative terminal (NT) of the battery 14 and the vehicle load group 52. The positive contact switch 54 and the negative contact switch 64 are opened when the vehicle 20 is not turned on and are closed during charging and driving operations.

The vehicle load group 52 may include an auxiliary power module 58, a heater 60, an air compressor control unit 62, and other devices 64 for the operation of the vehicle 10. The auxiliary power module 58 is configured to generate the low-voltage power to the vehicle 10 from the high voltage bus. The heater 60 is configured to generate heat which may be used to warm the battery 14. The air compressor control unit 62 may include a sensor 66 for detecting the temperature of the battery 14.

The power control system 10 includes a third inverter 68 that is electrically coupled to the front-end rectifier 46 and is electrically coupled to the first inverter 28. The front-end rectifier 46 transforms the AC power to DC power. The third inverter 68 transforms the DC power back to AC power for transmission to the outlet 12. The DC power output from the third inverter 68 is transmitted to the first inverter 28 wherein the first inverter 28 transforms the DC power to AC power which is transmitted to the winding machine 32. The winding machine 32 transmits the AC power to the second inverter 30 wherein the second inverter 30 transforms the AC power to DC power to charge the battery 14.

The power control system 10 includes a first switch 70 and a second switch 72. The first switch 70 is interposed between the positive bus 50A and the positive bus of the first inverter 28 and the second switch 72 is interposed between the negative bus 50B and the negative bus of the first inverter 28. The first switch 70 and the second switch 72 may be opened or closed to electrically disconnect and connect the second inverter 30 to the first inverter 28. In aspects where the first switch 70 and the second switch 72 are open, the first inverter 28 and the second inverter 30 are galvanically isolated from each other, thus operation of the first inverter 28 does not interfere with the operation of the second inverter 30 and the third inverter 68. As such, the charging of the battery 14 is not affected by the supply of power to the outlet 12.

The power control system 10 includes an onboard charger module 74 including a first processing unit 76 configured to process the electric power from the first power source 16 to charge the battery 14 and provide power to the outlet 12 simultaneously. The first processing unit 76 includes a non-volatile memory that stores written instructions for the execution of the onboard charger module 74 to include sending commands for the operation of the first inverter 28, the second inverter 30, the winding machine 32, the front-end rectifier 46, the first DC port switch 40, the second DC port switch 42, the AC port switch 48, the vehicle load group 52, the positive contact switch 54, the negative contact switch 56, the third inverter 68, the first switch 70 and the second switch 72. For illustrative purposes, the onboard charger module 74 is shown as a unit that transmits signals to the power control system 10 as indicated by the lightning bolt. However, it should be appreciated that the onboard charger module 74 may be placed in electrical communication with the components of the power control system 10 using a bus, a wire or an electric trace of a bus board. For instance, the onboard charger module 74 may send a gate signal to the MOSFETs of the first inverter 28, the second inverter 30, the front-end rectifier 46 and the third inverter 68 to execute a transformation of direct current to alternating current or alternating current to direct current as the case may be. Further, the onboard charger module 74 may transmit gate signals to the switches 40, 42, 48, 64, 66, 70 and 72 that opens and closes the switches 40, 42, 48, 64, 66, 70 and 72 to control the supply of power between the components of the power control system 10.

The power control system 10 may be further configured to execute a series of steps to optimize battery charging operations. In one aspect, the onboard charger module 74 receives a signal from the charging inlet 22 that power is being received. In which case, the onboard charger module 74 actuates the auxiliary power module 58 to generate the required low-voltage power. The onboard charger module 74 receives the temperature of the battery 14 from the sensor 66 or from the serial data and determines if the temperature of the battery 14 is above a predetermined threshold. For illustrative purposes, assume that the predetermined threshold is zero degrees Celsius. The onboard charger module 74 instructs the first switch 70 and the second switch 72 to be in the open position and the positive contact switch 54 and the negative contact switch 64 are closed to place the battery 14 and the outlet 12 into electric communication with the first power source 16. If the temperature of the battery 14 is above the predetermined threshold, the third inverter 68 is actuated wherein power from the first power source 16 is transmitted to the outlet 12 while the battery 14 is being charged. If the temperature of the battery 14 is at or below the predetermined threshold, the onboard charger module actuates the heater 60 to warm up the battery 14. The sensor 66 continues to monitor the battery 14 and the onboard charger module 74 instructs the positive contact switch 54 and the negative contact switch 64 to close and then actuates the third inverter 68 when the temperature of the battery 14 exceeds the predetermined threshold and thus power from the first power source 16 is transmitted to the outlet 12 while the battery 14 is being charged.

With reference again FIG. 4, in one aspect, the rectifier 46 converts AC power into DC power and transmits power to the first inverter 28. The first inverter 28 transmits the power to the winding machine 32, which transmits power to the second inverter 30. In one aspect, the third inverter 68 includes a pair of capacitors and MOSFET switches coupled to an AC filter 78, which filters the power prior to being received by the outlet 12. In one aspect, the third inverter 68, 68a may be further configured to step up or step down the voltage from the first power source 16. For instance, if the first power source 16 provides 120 volts of AC power and the outlet 12 is configured to provide AC power at 120 volts, it should be appreciated that the third inverter 68, 68a does not need to perform a step-up or step-down operation. However, if the first power source 16 is configured to provide 120 volts of AC power and the outlet 12 is configured to provide 240 volts of AC power, the third inverter 68, 68a may be configured to step up the power from the first power source 16 to provide 240 volts of AC power to the outlet 12.

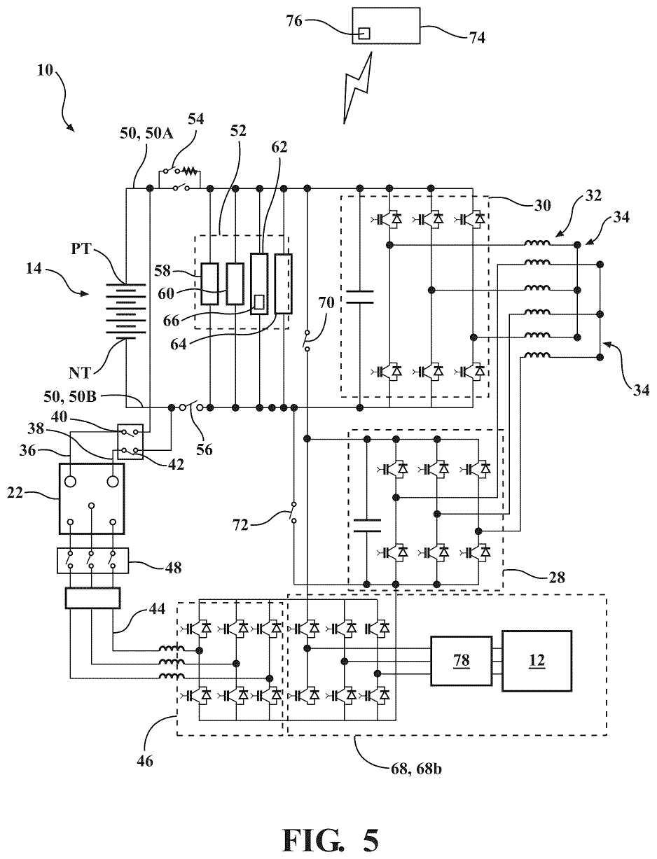

With reference now to FIG. 5, the power control system 10 may be further configured to handle a first power source 16 configured to output power in a three-phase form. In such an aspect, the third inverter 68b is configured as a three-phase inverter. In one aspect, the three-phase inverter may include three pairs of MOSFET switches in parallel with each other, and each pair of MOSFET switches are configured to not only transform the DC power from the front-end rectifier 46 to AC power, but also transmit power at three different phases to the outlet 12. FIG. 5 also depicts an aspect where not only is power delivered to the outlet 12 at three phases, but the power from the first power source 16 may be stepped up or stepped down to comport with the requirements of the outlet 12. In particular, power from the third inverter 68b is passed through an AC filter 78. As described above, the AC filter 78 is configured to filter noise from the power and the third inverter 68b may be further configured to step up or step down power. Thus, in instances where the first power source 16 provides 120-volt AC power at three-phases and the outlet 12 is configured to 120 volts of power at three-phases, it should be appreciated that the third inverter 68b need not perform a step-up or step-down operation. However, if the first power source 16 is configured to provide 120 volts of AC power and the outlet 12 is configured to provide 240 volts of AC power, the third inverter 68b may be configured to step up the power from the first power source 16 to provide 240 volts of AC power to the outlet 12.

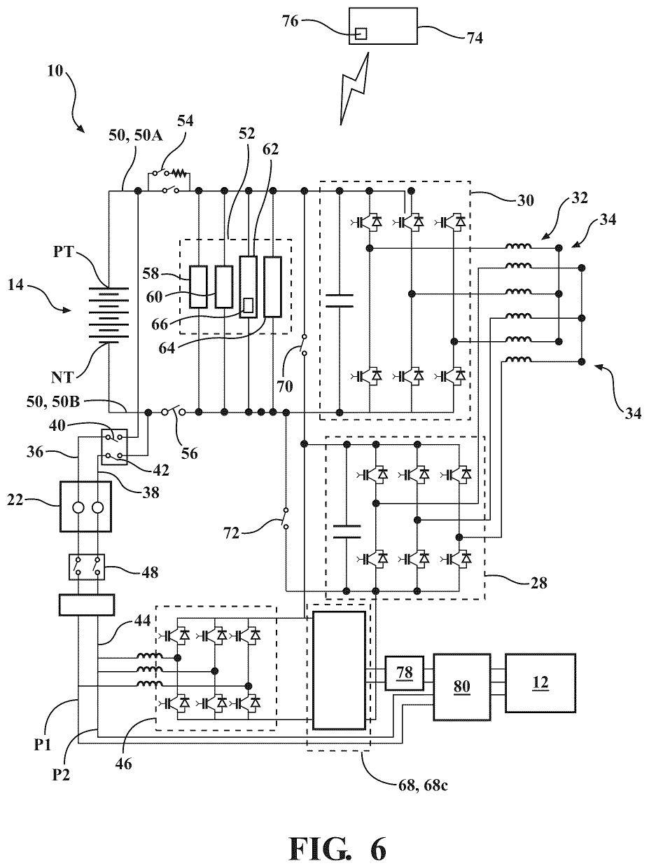

With reference now to FIG. 6, the power control system 10 another configuration of the third inverter 68c is provided. The third inverter 68c may be a single-phase inverter, wherein power transmitted by the front-end rectifier 46 is transformed into a single-phase form. In such an aspect, the front-end rectifier 46 receives power from the first power source 16 in three distinct phases as indicated by the three lines coupling the charging inlet 22 to the front-end rectifier 46. In such an aspect, the power control system 10 may further include a relay matrix 80 which is configured to provide power directly from the charging inlet 22 to the outlet 12 or provide a stepped up or stepped down power from the third inverter 68c. In such an aspect, in a case where 120 volts is received from the charging inlet 22 and the outlet 12 is configured to provide 120 volts of power, the front-end rectifier 46 may be turned off forming an open circuit. In which case, power from the charging inlet 22 is transmitted directly to the relay matrix 80 along power lines P1 and P2 wherein the relay matrix 80 feeds the power to the outlet 12. In a case where 120 volts is received from the charging inlet 22 and the outlet 12 is configured to provide 240 volts of power, the front-end rectifier 46 may be turned on forming a closed circuit, in which case power from the charging inlet 22 is transmitted directly to the relay matrix 80 along power lines P1 and P2 and to the front-end rectifier 46. The front-end rectifier 46 transforms the power to DC power and the third inverter 68c transforms the DC power to AC power and steps up the power to 240 volts, wherein the relay matrix 80 processes power from the third inverter 68c and power lines P1 and P2 to generate 240 volts of power to be fed to the outlet 12. It should be appreciated that in aspects where 240 volts is received from the charging inlet 22 and the outlet 12 is configured to provide 120 volts of power, the front-end rectifier 46 may be turned on forming a closed circuit. In which case, power from the charging inlet 22 is transmitted directly to the relay matrix 80 along power lines P1 and P2 and from the front-end rectifier 46 to the third inverter 68c. The third inverter 68c steps down the power and transmits the stepped down power to the relay matrix 80 which mixes power from power lines P1 and P2 and the third inverter 68c to generate 120 volts of power to be fed to the power to the outlet 12.

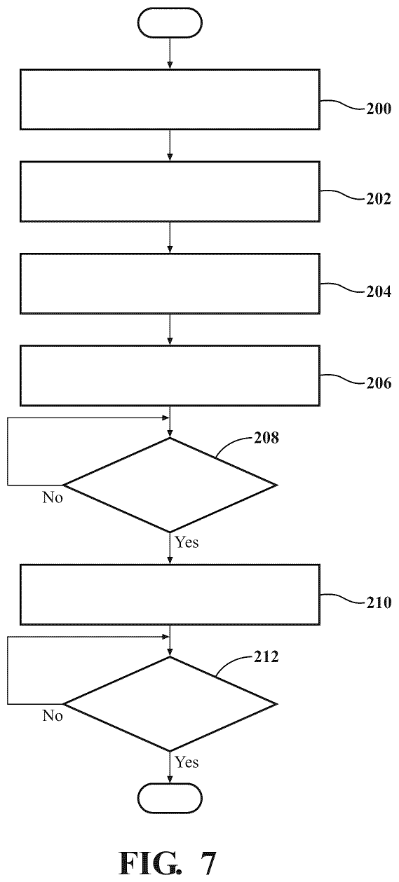

With reference now to FIG. 7, a method of providing electric power from a first power source 16 to an outlet 12 while simultaneously charging a battery 14 of an electric vehicle 20 is provided. The battery 14 is configured to power a motor 26 that drives the electric vehicle 20. The method may be implemented by an onboard charger module 74 configured to process the electric power from the first power source 16 to charge the battery 14 and provide power to the outlet 12. The onboard charger module 74 includes a first inverter 28, a second inverter 30, a winding machine 32 and a front-end rectifier 46. The front-end rectifier 46 transforms the electric power from an alternating current to a direct current. The first inverter 28 transforms the direct current to an alternating current and transmits the alternating current to the winding machine 32. The winding machine 32 transmits the alternating current to the second inverter 30. The second inverter 30 transforms the alternating current to a direct current and transmits the direct current to the battery 14 to charge the battery 14. A third inverter 68 is electrically coupled to the front-end rectifier 46 and is configured to transform the direct current from the front-end rectifier 46 to an alternating current and transmit the alternating current to the outlet 12 while the battery 14 is being charged.

At step 200, the power factor correction is performed. At step 202, the components of the vehicle load group 52 needed for battery charging operations are turned on. For instance, the heater 60, the auxiliary power module 58 and the air compressor control unit 62 are turned on. At step 204, a voltage and a current of the first power source 16 are brought into phase with the voltage and current of the battery 14. This may be performed by the front-end rectifier 46.

At step 206, the third inverter 68 is actuated and at step 208 a determination is made as to whether the temperature of the battery 14 is greater than a predetermined threshold, for instance if the temperature of the battery 14 is above zero degrees Celsius. Step 208 is performed until the temperature of the battery 14 is greater than the predetermined threshold. As the heater 60 is turned on, the temperature of the battery 14 is increased. At step 210, the positive contact switch 54 and the negative contact switch 64 are closed when the temperature of the battery is greater than the predetermined threshold. At step 212 the method continues to query if the charging is complete. The method ends at step 214 when charging operations are complete. It should be appreciated that charging operations may be complete when the battery 14 is fully charged or the charger 24 is disconnected from the charging inlet 22. In such a case, the vehicle 20 is disconnected from the first power source 16 and power to the outlet 12 is provided by the battery 14.

It should be appreciated that the method may be implemented irrespective of the power characteristics of the first power source 16. As such, the third invertor 68 may be configured to receive electric power in one of a single phase and three phases. Additionally, the third inverter 68 may be configured to step up and/or step down a voltage of the electric power to deliver power to the outlet at a predetermined voltage. As described above, such a feature is useful in instances where the first power source 16 provides 120 volts of power and the outlet 12 is configured to provide 240 volts of power.

The method may further include the step of providing a first switch 70 and a second switch 72. The first switch 70 is interposed between the battery 14 and the second inverter 30 and the second switch 72 is interposed between the battery 14 and the first inverter 28. The method includes the step of keeping the first switch 70 and the second switch 72 open when the battery 14 is being charged to provide a galvanic isolation between the electric power transmitted to the outlet 12 and the battery 14 during charging. As discussed above, when charging is complete and the charger 24 is disconnected from the charging inlet, the battery 14 provides power to the outlet 12 which may be done by closing the first switch 70 and the second switch 72.

In some implementations, the method further includes detecting a temperature of the battery and closing the positive contact switch 54 and the negative contact switch 64 when the temperature of the battery 14 is above the predetermined threshold and turning on the heater 60 to warm up the battery when the temperature of the battery is below the predetermined threshold. The method may include the step of keeping the positive contact switch 54 and the negative contact switch 64 in an open position until the temperature of the battery 14 is at or above the predetermined threshold. The method may include the step of closing the first switch 70 and the second switch 72 when the battery 14 provides power to the motor 26.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A power control system for providing electric power to an outlet and a battery, the battery configured to power a motor, the power control system providing the electric power to the outlet and the battery from a first power source, the power control system comprising:
an onboard charger module including a first processing unit configured to process the electric power from the first power source to charge the battery, the first processing unit including a non-volatile memory that stores written instructions for an execution of the onboard charger module; the onboard charger module including a first inverter, a second inverter, a winding machine and a rectifier, wherein the first inverter, the winding machine, and the second inverter are configured to transmit electric power from the first power source to the battery and the rectifier is configured to transform an alternating current from the first power source to a direct current;
a third inverter electrically coupled to the rectifier and the first inverter;
a first switch interposed between the battery and the first inverter;
a second switch interposed between the battery and the second inverter; and
wherein the first processing unit is further configured to retain the first switch and the second switch in an open position when the battery is being charged to provide a galvanic isolation between the battery and the third inverter while the battery is being charged, while the third inverter transforms the direct current from the rectifier to an alternating current and supplies the alternating current to the outlet to allow a load to be powered while the battery is being charged.

2. The power control system as set forth in claim 1, wherein the first switch is interposed between the battery and the second inverter and the second switch is interposed between the battery and the first inverter.

3. The power control system as set forth in claim 1, further including a positive contact switch and a negative contact switch, the positive contact switch interposed between a positive terminal of the battery and the second inverter and the negative contact switch interposed between a negative terminal of the battery and the second inverter.

4. The power control system as set forth in claim 1, wherein the third inverter is configured to provide a voltage to the outlet in a single phase.

5. The power control system as set forth in claim 1, wherein the third inverter is configured to provide a voltage to the outlet in at least two phases.

6. The power control system as set forth in claim 3, wherein the rectifier is further configured to bring a voltage and a current of the first power source into phase with a voltage and a current of the battery.

7. The power control system as set forth in claim 6, further including a heater and a sensor for detecting a temperature of the battery.

8. The power control system as set forth in claim 7, wherein the onboard charger module is further configured to open the first switch and the second switch and close the positive contact switch and the negative contact switch when the voltage and the current of the first power source is in phase with the voltage and current of the battery and the temperature of the battery is above a predetermined threshold.

9. The power control system as set forth in claim 8, wherein the onboard charger module is further configured to open the positive contact switch and the negative contact switch when the temperature of the battery is at or below the predetermined threshold.

10. The power control system as set forth in claim 9, wherein the onboard charger module is further configured to close the first switch and the second switch when the battery provides power to the motor.

11. A method of providing electric power from a first power source to an outlet while simultaneously charging a battery of an electric vehicle, the battery configured to power a motor, the motor configured to drive the electric vehicle, the method comprising the steps of:
providing an onboard charger module configured to process the electric power from the first power source to charge the battery, the onboard charger module including a first inverter, a second inverter, a winding machine and a rectifier, the rectifier transforming the electric power from an alternating current to a direct current, the first inverter transforming the direct current to an alternating current and transmitting the alternating current to the winding machine, wherein the winding machine transmits the alternating current to the second inverter, the second inverter transforming the alternating current to a direct current and transmitting the direct current to the battery to charge the battery; and
providing a third inverter electrically coupled to the rectifier and configured to transform the direct current from the rectifier to an alternating current and transmit the alternating current to the outlet while the battery is being charged.

12. The method as set forth in claim 11, wherein the third inverter is configured to receive electric power in one of a single phase and three phases.

13. The method as set forth in claim 11, further including the steps of providing a first switch and a second switch, wherein the first switch is interposed between the battery and the second inverter and the second switch is interposed between the battery and the first inverter and keeping the first switch and the second switch open when the battery is being charged to provide a galvanic isolation between the electric power transmitted to the outlet and the battery during charging.

14. The method as set forth in claim 13, further including the step of providing a positive contact switch and a negative contact switch, the positive contact switch interposed between a positive terminal of the battery and the second inverter and the negative contact switch interposed between a negative terminal of the battery and the second inverter.

15. The method as set forth in claim 14, further including the step of bringing a voltage and a current of the first power source into phase with a voltage and a current of the battery.

16. The method as set forth in claim 15, further including the step of detecting a temperature of the battery and closing the positive contact switch and the negative contact switch when the temperature of the battery is above a predetermined threshold.

17. The method as set forth in claim 16, further including the steps of providing a heater and turning on the heater to warm up the battery when the temperature of the battery is below the predetermined threshold.

18. The method as set forth in claim 17, further including the step of keeping the positive contact switch and the negative contact switch in an open position until the temperature of the battery is at or above the predetermined threshold.

19. The method as set forth in claim 18, further including the step of closing the first switch and the second switch when the battery provides power to the motor.

20. The method as set forth in claim 19, wherein the third inverter is configured to step up and step down a voltage of the electric power.
